(19) United States
(12) Patent Application Publication
(10) Pub. No.: US 2009/0063025 A1
(43) Pub. Date: Mar. 5, 2009

(54) METHOD AND DEVICES EQUIPPED WITH A HIGH-PASS FILTER FOR APPRAISAL OF THE KNOCKING IN EVERY CYLINDER OF AN INTERNAL COMBUSTION ENGINE

(75) Inventors: Pasquale Forte, Orsenigo (IT); Stefano Bordegnoni, Orsenigo (IT); Andrea Gelmetti, Orsenigo (IT)

Correspondence Address: GREER, BURNS & CRAIN, 300 S WACKER DR, 25TH FLOOR, CHICAGO, IL, 60606, US

(73) Assignee: ELDOR CORPORATION S.P.A., Orsenigo (IT)

(21) Appl. No.: 12/161,779

(22) PCT Filed: Jan. 17, 2007
(86) PCT No.: PCT/EP07/00369

§ 371 Date: Sep. 12, 2008

(30) Foreign Application Priority Data
Jan. 24, 2006 (IT) MI2006A000105
Mar. 30, 2006 (IT) MI2006A000598

(51) Int. Cl. F02D 45/00

(52) U.S. Cl. 701/111; 73/114.02

(57) ABSTRACT

The invention relates to the field of methods and devices for evaluating the knocking inside every cylinder of an internal combustion engine by making advantageous use of the ionisation current generated during the combustion of the fuel in each cylinder of said engine. The invention develops over various phases, each of which is repeated continually for each cycle of said combustion engine and is characterised by the fact that ionisation current values are selected during determined lengths of time, and said values are entered in a high-pass filter, the values determined by said filter then being squared and the value Vd calculated, said value being the relation between the value of the sum of the squares of said values obtained by said filter and a known normalisation coefficient, thus generating the spark at the spark plug in each cylinder on the basis of said value Vd.

### TECHNICAL FIELD

The present invention relates to a method and devices therefor for evaluating the detonation inside every cylinder of an internal combustion engine. In particular, a method to evaluate said detonation by means of the measurement of the ionisation current values in each cylinder of an internal combustion engine in a determined interval of time and the calculation of a value on the basis of which the spark will be generated at the spark plug according to the value calculated.

### BACKGROUND ART

The detonation of the air-combustible mix in the cylinder of an internal combustion engine causes vibrations and can damage the engine if said vibrations are high.

The evaluation of said detonation is likewise one of the elements of fine-tuning of an internal combustion engine.

The devices and methods currently utilised and available on the market to evaluate said detonation are based on the use of piezoelectric sensors installed in the engine body which produce a signal proportional to the acceleration of the engine body.

These sensors are utilised as it is known that said detonation causes oscillations at known frequencies. The detonation level in a cylinder of an internal combustion engine can therefore be determined by filtering the sensor signal by means of a band-pass filter and evaluating the signal filtered to calculate the energy thereby produced.

This method, part of the commonly known technique, has various drawbacks. The most relevant drawbacks are constituted of the possibility of the sensors failing to work and the energy produced by the detonation failing to be calculated due to a high degree of disturbance of the sensor signal in some engine types.

### DISCLOSURE OF INVENTION

The aim of the present invention is to identify a method and devices therefor for evaluating the detonation inside each cylinder of an internal combustion engine accurately and reliably, avoiding the use of sensors and effecting said evaluation for each cylinder of said engine.

The present invention is based on the advantageous use of the ionisation current developed during the combustion of the fuel in each cylinder of said engine, since the number of ions in said ionisation current has a close correlation with the quantity of energy developed by the detonation of the air-combustible mix in each cylinder of an internal combustion engine.

The present invention is based on the use of the ionisation current released by a device positioned on each cylinder of said engine. This ionisation current is measured by a Control Unit commonly utilised for the management of said combustion engines. Said Control Unit is endowed with a high-pass filter and means, preferably electronic ones, which implement the method of the present invention. The aims and advantages of the present invention will better emerge in the description that follows and the plates enclosed of an internal combustion engine with a sole cylinder, illustrated purely in the form of a non-limiting example, in which:

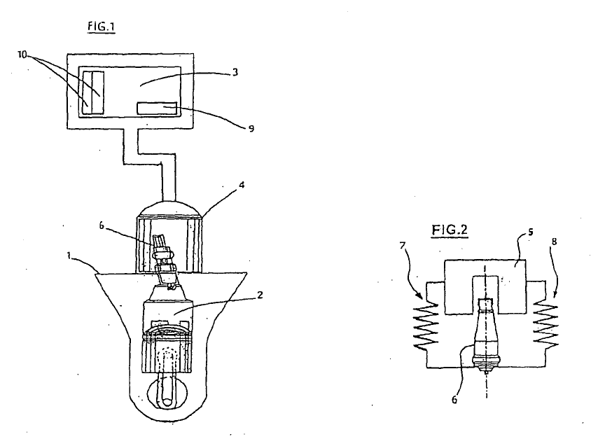

FIG. 1 illustrates a schematic view of the engine which utilises the method and the Control Unit in which the means that implement the invention in question are housed;

FIG. 2 illustrates a schematic view of the device positioned above each cylinder of the engine according to the invention in question;

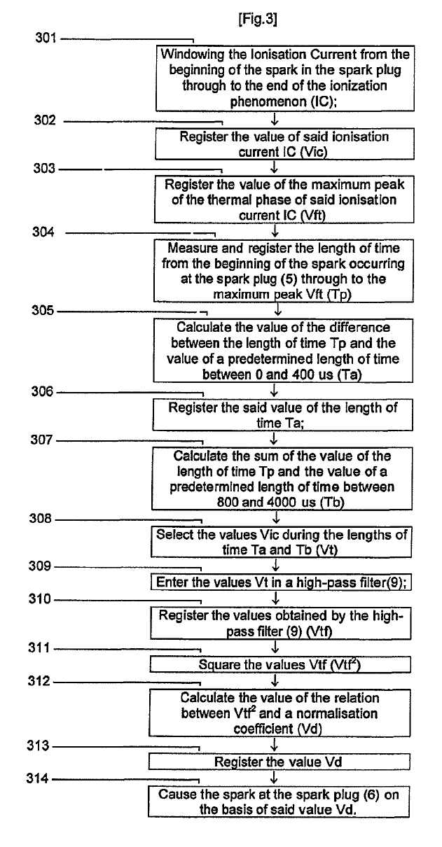

FIG. 3 illustrates, schematically, the flow chart relating to the method according to the invention in question.

With reference to FIG. 1, (1) indicates an internal combustion engine as a whole, a device (4) is shown, positioned above the cylinder which, in addition to creating the spark, by means of the spark plug (6), necessary to realise the combustion inside cylinder, releases the ionisation current, indispensable to implement the method in question, and a cylinder (2) is shown, into which the combustible is admitted. This figure also shows a Control Unit (3) endowed with a high-pass filter with cut-off frequency between 2 KHz and 8 KHz (9) and the means (10) to implement the method.

With reference to FIG. 2, said figure indicates the part of the device in question in the invention, positioned above the cylinders, which, in addition to creating the spark necessary to realise the combustion inside the cylinder, produces the ionisation current indispensable for implementing the method in question. This part of the device (4) is constituted of a coil (5) and a spark plug (6).

These two elements (5) and (6) are mutually connected by a polarisation circuit (7) and an acquisition circuit (8).

With reference to FIG. 3, said figure indicates a flow chart which schematically illustrates the method in question in the invention. This method develops over various phases, which are repeated for each cycle of the engine (1) and to which the relative means (10) correspond, said means being preferably electronic. In a first phase (301), the measurement of the ionisation current (IC) present in each cylinder is effected from the beginning of the spark occurring in the spark plug (3) through to the end of the ionisation phenomenon. Said ionisation current is released by means of the device (2) which, in addition to creating the spark necessary to realise the combustion of the air-combustible mix inside the cylinder, releases the ionisation current, referred to as IC. After measuring said ionisation current (IC), there is a second phase (302) which envisages the registration of the value of said ionisation current IC, referred to as Vic. In the subsequent phase (303), the value of the maximum peak of the thermal phase of said ionisation current IC is registered, referred to as Vft. Phase (304) envisages the measurement and registration of the length of time from the beginning of the spark occurring at the spark plug (5) through to the maximum peak Vft, said length of time being referred to in the present invention as Tp. The following phase (305) envisages the calculation of the value of the difference between the length of time Tp and the value of a predetermined length of time of between 0 and 400 us. Said difference is referred to in the present invention as Ta. The value of Ta is registered in the subsequent phase (306). The method of the present invention continues with phase (307) which envisages the calculation of the sum of the value of the length of time Tp and the value of the predetermined length of time between 800 and 4000 us, referred to as Tb. The subsequent phase (308) envisages the selection of the values of the ionisation current IC registered in the previous phase (302), during the lengths of time Ta and Tb. Said selected values are referred to in the present invention as Vt. In the subsequent phase (309), the values Vt are admitted to a high-pass filter with cut-off frequency between 2 KHz and 8 KHz (9), which determines a value, registered in phase (310), referred to as Vtf. The subsequent phase (311) of the present invention envisages the calculation of the squares of the values Vtf, registered in the previous phase. Said values are referred to in the present invention as Vtf². The subsequent phase (312) is dedicated to calculating the value of the sum of the values Vtf², calculated in the previous phase. The value determined in phase 312 is referred to in the present invention as ΣVtf². The subsequent phase (313) is dedicated to calculating the relation between the value ΣVtf² and a normalisation coefficient, known by field technicians. The value determined in phase (313) is referred to in the present invention as Vd. After the registration of the value Vd, effected in phases (314), the final phase of the method of the present invention is phase (315), in which the spark is generated at the spark plug (6) on the basis of the value Vd. The description above and the plates enclosed illustrate one embodiment of the present invention and constitute a non-limiting example thereof within the scope of protection as per the following claims.

1. A method for evaluating the knocking inside each cylinder of an internal combustion engine (1) equipped with one or more cylinders (2) and having a Control Unit (3) endowed with a high-pass filter with cut-off frequency between 2 KHz and 8 KHz (9) electronic means performing the method and device (4) for each cylinder connected to the Control Unit (3) comprising a coil (5) and a spark plug (6) to generate the spark, a polarisation circuit (7) to generate the ionisation current (IC), an acquisition circuit (8) for measuring the ionisation current (IC), characterised by the fact that said method using said ionisation current (IC) comprises the following phases performed by the Control Unit (3): (301) windowing, in the cylinder (2) of said engine (1), of the ionisation current (IC) from the beginning of the spark occurring in the spark plug (6) through to the end of the ionisation phenomenon; (302) registration of the values of said ionisation current IC (Vic); (303) registration of the value of the maximum peak of the thermal phase of said ionisation current IC (Vft); (304) measurement and registration of the length of time from the beginning of the spark occurring at the spark plug (5) through to the maximum peak Vft (Tp); (305) calculation of the value of the difference between the length of time Tp and the value of a predetermined length of time between 0 and 400 us (Ta); (306) registration of the said value of the length of time Ta; (307) calculation of the sum of the value of the length of time Tp and the value of a predetermined length of time between 800 and 4000 us (Tb); (308) selection of the values Vic during the lengths of time Ta and Tb (Vt); (309), entry of the values Vt in a high-pass filter with cut-off frequency between 2 KHz and 8 KHz (9); (310) registration of the values determined obtained by the high-pass filter (9) (Vtf); (311) squaring of the values Vtf (Vtf²); (312) calculation of the value of the sum of the values Vtf², (ΣVtf²); (313) calculation of the value of the relation between ΣVtf² and a normalisation coefficient (Vd); (314) registration of the value Vd; (315), generation of the spark at the spark plug (6) on the basis of said value Vd.

2. A device for evaluating the knocking inside each cylinder of an internal combustion engine (1) equipped with one or more cylinders (2) and placed into a Control Unit (3) endowed with a high-pass filter with cut-off frequency between 2 KHz and 8 KHz (9) connected to a device (4) for each cylinder comprising a coil (5) and a spark plug (6) to generate a spark, a polarisation circuit (7) to produce the ionisation current (IC), an acquisition circuit (8) for measuring the ionisation current (IC), characterised by the fact that said control unit comprises means (10) with which to continually: (301) windowing, in the cylinder (2) of said engine (1), the ionisation current (IC) from the beginning of the spark occurring in the spark plug (6) through to the end of the ionisation phenomenon; (302) register the values of said ionisation current IC (Vic); (303) register the value of the maximum peak of the thermal phase of said ionisation current IC (Vft); (304) measure and register the length of time from the beginning of the spark occurring at the spark plug (5) through to the maximum peak Vft (Tp); (305) calculate the value of the difference between the length of time Tp and the value of a predetermined length of time between 0 and 400 us (Ta); (306) register the said value of the length of time Ta; (307) calculate the sum of the value of the length of time Tp and the value of a predetermined length of time between 800 and 4000 us (Tb); (308) select the values Vic during the lengths of time Ta and Tb (Vt); (309), enter the values Vt in a high-pass filter with cut-off frequency between 2 KHz and 8 KHz (9); (310) register the values obtained by the high-pass filter (9) (Vtf); (311) square the values Vtf (Vtf²); (312) calculate the value of the sum of the values Vtf², (ΣVtf²); (313) calculate the value of the relation between ΣVtf² and a normalisation coefficient (Vd); (314) register the value Vd; (315), generate the spark at the spark plug (6) on the basis of said value Vd.
